(19) United States
(12) Patent Application Publication
(10) Pub. No.: US 2025/0224532 A1
(43) Pub. Date: Jul. 10, 2025

(54) SYSTEM AND METHOD OF OBJECT CLASSIFICATION AND DETECTION USING MAGNETIC PROPERTY ARRAY-BASED OBJECT DETECTION SYSTEM

(71) Applicant: Xtract One Technologies Inc., Toronto (CA)

(72) Inventors: Elliot Mark HOLTHAM, Vancouver (CA); Keegan Jan LENSINK, Delta (CA); Nevine DEMITRI, Toronto (CA)

(21) Appl. No.: 18/852,930

(22) PCT Filed: Apr. 4, 2023
(86) PCT No.: PCT/CA2023/050459

§ 371 Date: Sep. 30, 2024

Related U.S. Application Data
(60) Provisional application No. 63/326,926, filed on Apr. 4, 2022.
(60) Provisional application No. 63/336,325, filed on Apr. 29, 2022.
(60) Provisional application No. 63/483,297, filed on Feb. 5, 2023.

(51) Int. Cl. G01V 3/10; G01V 3/38; H01F 7/02

(52) U.S. Cl. CPC G01V 3/10; G01V 3/38; H01F 7/0221; H01F 7/0273

(57) ABSTRACT

A system and method to create a static (DC) or near static magnetic field either using permanent magnets or a transmitter loop. The field magnetizes the objects as they pass through the field and response based on the volume of the material and the magnetic susceptibility. By making measurements of the resulting magnetic field (B field or in this case dB/dt), the system can measure how magnetized the object becomes. This property can be used alone and just recover information about magnetic susceptibility, or this information can be combined with other physical properties such as permanent magnetization or other properties such as electrical conductivity.

### CROSS REFERENCE TO RELATED APPLICATIONS

The application claims priority and the benefit of U.S. Provisional Patent Application Ser. No. 63/326,926, entitled “SYSTEM AND METHOD OF OBJECT CLASSIFICATION USING MAGNETIC PROPERTIES” filed on Apr. 4, 2022, U.S. Provisional Patent Application Ser. No. 63/336,325, entitled “WIRE-FREE MULTI-SENSOR GATEWAY FOR DETECTION OF PERSON-BORNE THREATS” filed on Apr. 29, 2022, U.S. Provisional Patent Application Ser. No. 63/483,297, entitled “SYSTEM AND METHOD OF OBJECT DETECTION USING A MULTI PROPERTY ARRAY BASED OBJECT DETECTION SYSTEM” filed on Feb. 5, 2023 and U.S. patent application Ser. No. 18/093,937, entitled “SYSTEM AND METHOD SMART STAND-ALONE MULTI-SENSOR GATEWAY FOR DETECTION OF PERSON-BORNE THREATS” filed on Jan. 6, 2023, the disclosures of which are incorporated herein by reference in its entirety. This application is also a national phase entry of International Application Serial No. PCT/CA2023/050459, entitled “SYSTEM AND METHOD OF OBJECT CLASSIFICATION AND DETECTION USING MAGNETIC PROPERTY ARRAY-BASED OBJECT DETECTION SYSTEM” filed on Apr. 4, 2023, the disclosure of which are incorporated herein by reference in its entirety.

### BACKGROUND

The embodiments described herein relate to security and surveillance, in particular, technologies related to threat detection via electronic means.

Most metal detector systems look at the electrical conductivity of the objects and also involve active current transmitter loops. One embodiment of this disclosure discusses using no electrical transmitter loops and classifiers off of the magnetic properties of the object which is a different physical property than the typical electrical conductivity that is used.

Traditionally targeted magnet sensors (TMS) systems detect permanently magnetized objects, not metal. The sensors in the TMS systems measure changes in the magnetic field around the pillar. When magnetic objects pass through the gateway, they change the field.

Most weapons of interest are constructed with ferrous metals, giving them the ability to be magnetic. However, many of the problematic benign objects are more magnetic than weapons. Two equally magnetic objects create the exact same magnetic field at a distance. If one only measures how magnetic an object is, the TMS system has no way to differentiate between magnetic benign and threat objects. This can be shown in FIG. 1 which illustrates graphs of magnetic fields for a steel ball bearing and magnet wallet. According to FIG. 1, the magnetic signature of a magnetic wallet and a 4″ steel ball bearing (approximately 10 lbs.) may exhibit similar magnetic signature. In certain instances, the 4″ steel ball bearing may have a lower signature.

In typical gateway systems, the pillars on each side of a lane are usually connected, either at the top by an arch or at the bottom, to power the system and transfer data from a secondary pillar to a primary pillar. This makes it difficult for the systems to be concealed and blend in the environment they are deployed in. For pillars connected at the floor level, a base plate has to be constructed to protect wires and avoid tripping people passing through the system. Further, these systems are bulky, and difficult to move around. They typically need to be installed in a fixed location and are less suited as a mobile solution.

There is a desire for a system to classify or characterize objects of interest (e.g., weapons, wallets, benign objects) as a threat or not, using the magnetic properties of the object.

### SUMMARY

A system and method to create a static (DC) or near static magnetic field either using permanent magnets or a transmitter loop. The field magnetizes the objects as they pass through the field and the response is based on the volume of the material and the magnetic susceptibility and the geometry of the object. By making measurements of the resulting magnetic field (B field or in this case dB/dt), the system is able to measure how magnetized the object becomes. This property can be used alone and just recover information about magnetic susceptibility, or this information can be combined with other physical properties such as permanent magnetization or other properties such as electrical conductivity.

A system and method of object detection using a multi-property array-based object detection system. A hybrid multi-sensor gateway (MSG) system combines the two current MSG 1 & MSG 2 system transmitters and receivers into a single gateway. The hybrid system consists of the backbone of the system is the MSG 2 system with an active transmitter loop which induces eddy currents to flow within conductive targets. Acquisition parameters such as transmitter pulse base frequency, waveform shape, ramp-time and peak current etc. can be modified and tuned to the specific applications and expected targets.

### BRIEF DESCRIPTION OF THE DRAWINGS

FIG. 1 is a diagram illustrating graphs of magnetic fields for a steel ball bearing and magnet wallet.

FIGS. 2A-2C are diagrams illustrating an exemplary threat detection system.

FIG. 3 is a block diagram illustrating an exemplary threat detection system.

FIG. 4 is graph illustrating measuring induced magnetism.

FIG. 5 is a diagram illustrating regions of effect of permanent magnetism and induced magnetism.

FIG. 6 is a diagram illustrating a targeted magnet sensors (TMS) demo system.

FIG. 7 is a diagram illustrating line graphs of ferrous objects as measured by a TMS system.

FIG. 8 is a diagram illustrating line graphs of permanent magnet as measured by a TMS system.

FIG. 9 is a diagram illustrating line graphs of SW357 as measured by a TMS system.

FIG. 10 is a diagram illustrating line graphs of a magnetic phone case as measured by a TMS system.

FIG. 11 is a diagram illustrating threat detection improvements by a TMS system.

FIG. 12 is a diagram illustrating false positive improvements by a TMS system.

FIG. 13 is a diagram illustrating the upper bound performance by a TMS system.

FIG. 14 is a diagram illustrating an improved TMS demo system with reduced detection delay.

FIG. 15 is a diagram illustrating a pillar of a revised TMS demo system.

FIG. 16A is a line drawing of a perspective view of a pair of pillars of an exemplary threat detection system.

FIG. 16B is a line drawing of a front plan view of a pair of pillars of the exemplary threat detection system.

FIG. 16C is a line drawing of a perspective view of a pair of pillars of an exemplary threat detection system showing an array of magnets.

FIG. 17A is a diagram illustrating an assembled view of the magnet assembly.

FIG. 17B is a diagram illustrating an exploded view of the magnet assembly.

FIG. 18A is a diagram describing elements of one example implementation of an exemplary hybrid gateway system.

FIG. 18B is a diagram describing elements of further embodiment of the hybrid gateway system with an embedded computer.

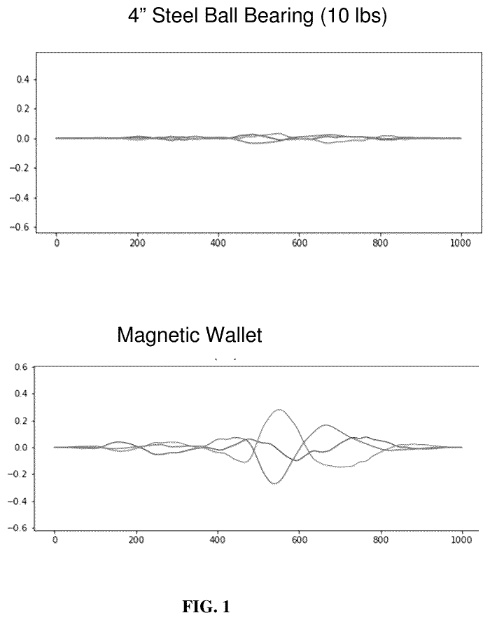

### DETAILED DESCRIPTION

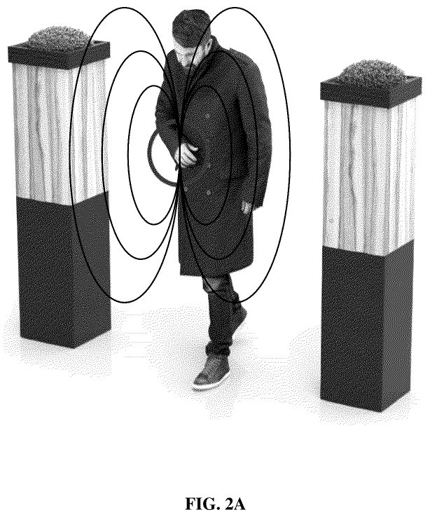

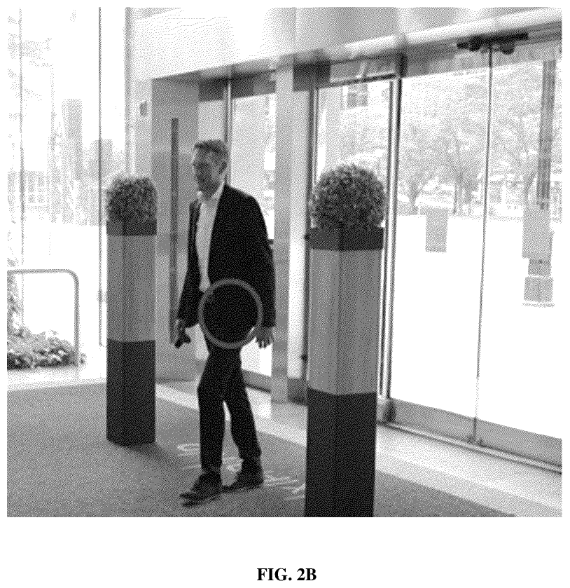

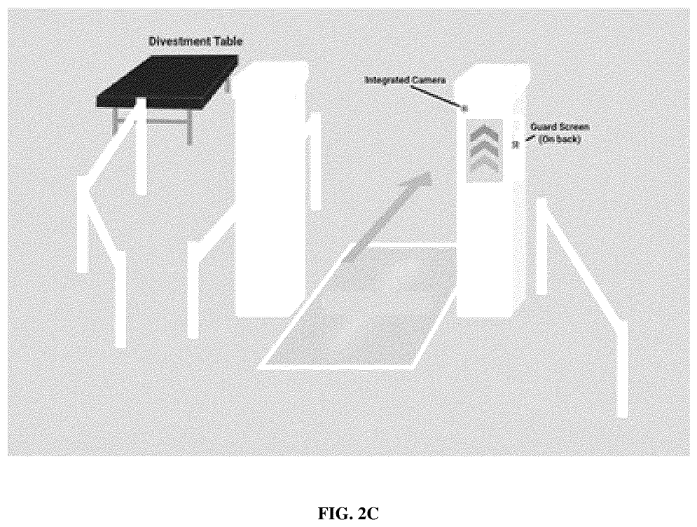

FIGS. 2A-2C are diagrams illustrating an exemplary threat detection system. FIG. 2A is a diagram illustrating a person with a concealed object passing through pillars of a targeted magnet sensors (TMS) system. According to FIG. 2A, a person may be carrying a magnetic wallet which is a benign object. The magnetism of benign and threat objects may overlap, leading to inevitable false positives or false negatives.

FIGS. 2B-2C are diagrams illustrating an exemplary threat detection system deployed in planter boxes. FIGS. 2B-2C illustrated an exemplary threat detection system deployed in planter boxes. According to these figures, the planter boxes are deployed at the entrance to an office and/or a pair of pillars to control entry. A pair of planter box columns are placed sufficiently far apart (i.e., 2 meters).

Decorative plants, either fake or real, are placed on the planter boxes. The planter boxes or planter box columns are connected via concealed wires where a cover is placed on top. The concealed wires provide power and Ethernet connection between both columns. In further embodiments, the concealed wires can be replaced with a wireless connection or another type of data connection. The planter box columns contain sensors to implement a threat detection system. At least one of the columns will also have a power cord and/or connection to the internet.

FIG. 2B is a diagram of an exemplary threat detection system deployed in planter boxes in a front entrance of a building. As seen in FIG. 2B, two planter box columns are placed by the front door in a building. A person can be seen entering the building, walking through these planter box columns.

A threat detection system using a multi-sensor gateway (MSG), such as the Xtract One PATSCAN MSG offers detection of concealed weapons on people and in bags using artificial intelligence (AI) and/or machine learning (ML) coupled with magnetic moment techniques. The multi-sensor gateway (MSG) allows for the discovery of a “weapon signature” (i.e., object shape such as handguns, rifles, knives, or bombs). Its configuration can detect and identify where on the individual's body or bag the metal threat object resides.

As seen in FIG. 2B, the MSG threat detection system can detect a concealed object (i.e., round circle in image) and may infer that this can be a weapon threat. This information is sent to a central processor and is provided to an operator, security officers or to police enforcement. Further, the MSG threat detection system may be connected to an alert system where lights and sounds can be triggered once a threat is detected.

FIG. 2C is a diagram illustrating a standalone SmartGateway system. According to FIG. 2C the standalone SmartGateway system consists of two pillars of a threat detection system. One of these pillars will have an integrated camera, a display screen, and a guard screen (not shown). There may also be arrows to indicate the direction of traffic flow. Close by would be a divestment table where security personnel may search objects of the patron (e.g., backpack, handbag, laptop bags, etc.).

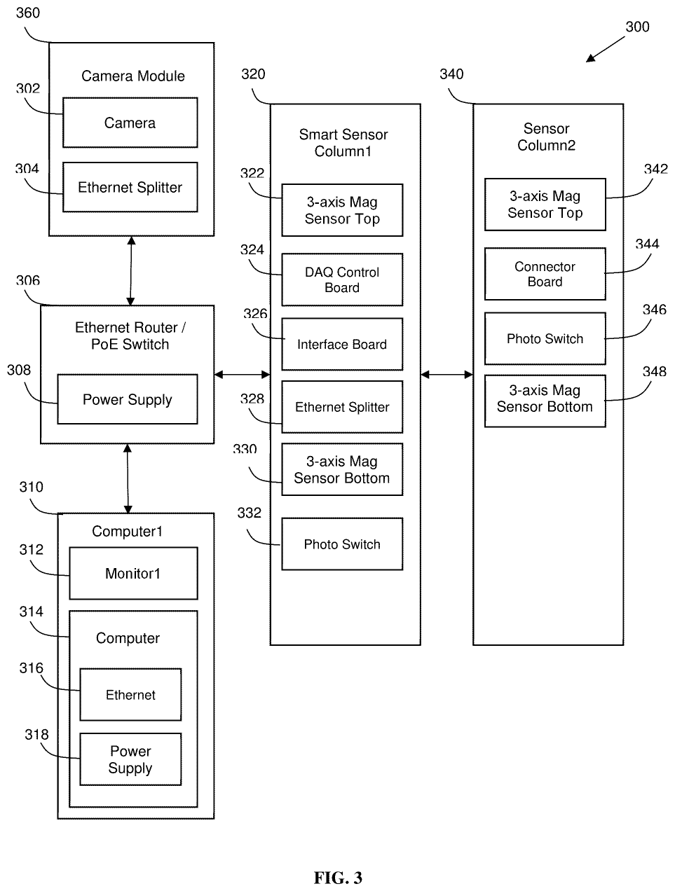

FIG. 3 is a block diagram illustrating an exemplary threat detection system. According to FIG. 3, the threat detection system 300 consists of a first sensor column 320 (i.e., smart column) includes a photoelectric sensor 332 (e.g., photo switch), a power supply 332, a computer control board 324 (e.g., a LabJack DAQ board), an interface board 326, a plurality of 3-axis magnetic sensors 322, 330. Connection interfaces for ethernet router 306, ethernet splitter 304, 328 and ethernet PoE (power of Ethernet) is also provided. Photoelectric sensor 332 may also include a photo emitter.

While Ethernet, and in particular powered Ethernet provides many advantages in reliably connecting the columns to the data analysis computer, several other power and connectivity options are available that would have a different set of advantages, for example connections to route the data could be WiFi® connections, BlueTooth® connections, short range wireless, WAN or cellular connections. In addition, power can be supplied to the columns via several means, including direct AC power connections, PoE, 12V DC connections, or battery connections. In future embodiments, first sensor column 220 may incorporate a computer processor.

The threat detection system 300 also consists of a second sensor column 340 comprising a second photoelectric sensor 346 (e.g., photo switch), a connector board 344 and a plurality of 3-axis magnetic sensors 342 and 348. A plurality of wires is provided to connect the interface board 326 of the first column 320 with the connector board 344 of the second column 340. Photoelectric sensors or photo switches 346, 332 are optical sensors that detect motion when people pass through. In further embodiments, sensor columns 320, 340 may include dedicated power supplies.

Attached to the first smart sensor column 320 includes an ethernet router and PoE (Power over Ethernet) switch 306, which can be connected to a 48V power supply 308, a computer system 310 and a camera module 360. Computer system 310 consists of monitor 312 and computer 314 which may be a laptop or small size computer unit. Computer 314 further comprises a computer processor (not shown), power supply 318 and ethernet connection 316. Camera module 360 consists of one or more camera 302 and ethernet splitter 304.

In further embodiments, the computer 310, 314 may be replaced by a processor housed within the sensor columns 320, 340. In further embodiments, the ethernet connection of threat detection system 200 may be replaced with a Bluetooth®, cellular or WiFI® wireless connection, thus removing the need for running ethernet cables.

According to the disclosure, a hybrid multi-sensor gateway (MSG) system combines the two current MSG 1 & MSG 2 system transmitters and receivers into a single gateway. The hybrid system consists of the backbone of the system is the MSG 2 system with an active transmitter loop which induces eddy currents to flow within conductive targets. Acquisition parameters such as transmitter pulse base frequency, waveform shape, ramp-time and peak current etc. can be modified and tuned to the specific applications and expected targets.

MSG 1 sensors are added to the system. While both MSG 1 and MSG 2 sensors are inductive coil sensors, the MSG 1 sensors are wound around a very high susceptibility material which greatly increases the sensitivity of the sensors. The downside of this core material is the MSG 2 transmitter can cause issues with the gain and saturation of the core material of the sensors and response causing artifacts.

The MSG 1 sensors are tuned for a much lower frequency than the MSG 2 sensors, typically recording responses in the 0.3-30 Hz frequency range which is needed to measure the low frequency passive response as magnetized objects pass through the gateway. Different embodiments of the hybrid system are possible including or not including the addition of the static magnetic array.

Further embodiments of the system are possible to combine transmitters and two types of receivers for getting usable data off the MSG 1 sensors while still using the active 2.0 transmitter. The first option is to leverage hardware filters and non-overlapping frequency ranges of the components. By using a higher frequency spectrum of the active transmitters (a few ms for a transmitter pulse) and the low frequency 0.3 Hz-10 Hz range of the 1.0 sensors, one can create frequency bands that don't overlap significantly so any active source pulse may be filtered out. Alternative embodiments are possible, where longer off-times are created for the MSG 2.0 transmitter pulses—in the long-off time regions between pulses, clean passive MSG 1 data could be collected with those sensors.

Alternative embodiments are also possible, where the MSG 2 transmitter is only fired during specific parts of the walk-through likely triggered off optical sensors or motion information. Various potential options include collecting active data at the midpoint of the walkthrough or first/second half of the walk through, while collecting passive data through the other portion of the walkthrough.

Disclosed herein is a system and method to make the TMS system more sensitive to threats and permanent magnets in different ways. The disclosed system has the following features:
Enables us to differentiate between large ferrous objects and small permanent magnets.
More reliable detection of threats.
Increases the performance of TMS and applicability of the product.

### Magnetism

A ferrous object can become magnetic in two ways: permanent magnetism or induced magnetism. Permanent magnetism is a static property that refers to an object that is inherently magnetic in nature (e.g., fridge magnet). Permanent magnetism depends on the history of the object (e.g., firing, heating, and manufacturing) and the magnetism varies for each instance. For example, two identical rifles can have different permanent magnetism properties.

Induced magnetism refers to an object becoming magnetic in the presence of an external magnetic field. Induced magnetism depends on the object's material, size, shape, and the external field. This property can be changed by changing the external field and the response is similar for every instance of the object.

Every magnetic object is some combination of permanent and induced magnetism and can be represented by the following equation:

$${m}_{total} = {m}_{induced} + {m}_{permanent}$$

wherein m_{induced}<<mₚₑᵣₘₐₙₑₙₜ for many threat objects. This is because induced magnetism requires an external field, and the external field of objects induced by the Earth's field is often relatively weak compared to typical remanent values of typical threat objects.

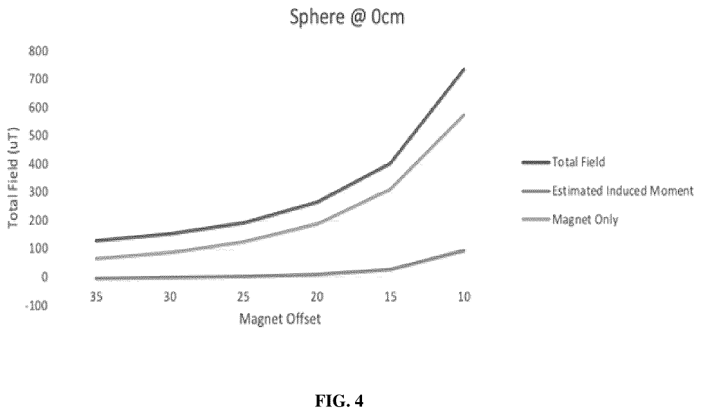

FIG. 4 is graph illustrating measuring induced magnetism.

### Magnetism in Threats

According to this disclosure, objects of interest can become magnetized by permanent magnetism or induced magnetisim.

### Permanent Magnetism

Incidental—unintentionally magnetized, often intentionally de-magnetized
Inconsistent—two AR15s could be magnetized completely differently.
Weak—relative to intentionally created magnets

### Induced Magnetism

Controllable—related to the field created.
Informative—depends on the object's material, size, shape.
Consistent—response is similar for every instance of the object.

According to this disclosure, some observations that are made to include threats that are more similar in material, shape, and size than permanent magnetism. In other words, it has been observed that magnetic properties of threats can be similar for dissimilar objects. The amplitude and geometry of the induced magnetic field captures information about the object's material, shape, and size. According to further embodiments, the geometry of the inducing field may also provide further characteristics of the object. Further, one can measure the induced magnetism by manipulating the external field. Furthermore, one key area that is identified is how an object becomes magnetized versus how magnetic an object was.

According to this disclosure, TMS system issues are likely due to our reliance on inconsistent permanent magnetism. Creating a static magnetic field in the gateway will allow one to measure induced magnetism. Induced magnetism is related to the object's material, shape, and size. Finally, small permanent magnets will not exhibit this behaviour. One can exploit this to increase our performance in detecting threats as there are now two independent physical properties with which to classify threat vs non-threat.

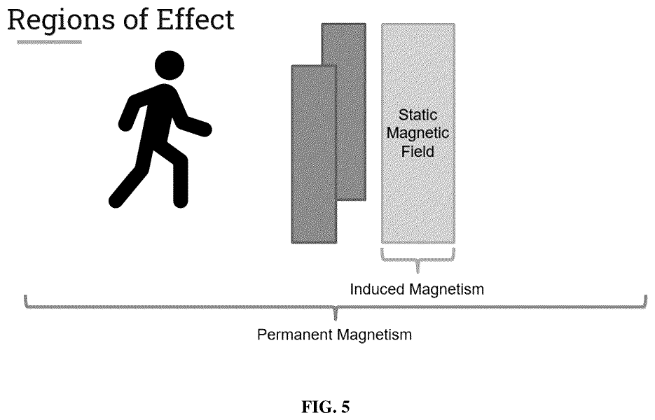

FIG. 5 is a diagram illustrating regions of effect of permanent magnetism and induced magnetism. According to FIG. 5, a person is shown walking past two pillars. The region of effect of the permanent magnetism will be the entire diagram. Induced magnetism is shown behind the two pillars across an area of static magnetic field.

According to further embodiments, the location and geometry of the inducing magnetic field can be placed in various positions. For example, it may make sense to have multiple static fields of different polarity and/or geometry placed at various positions for the walk-through.

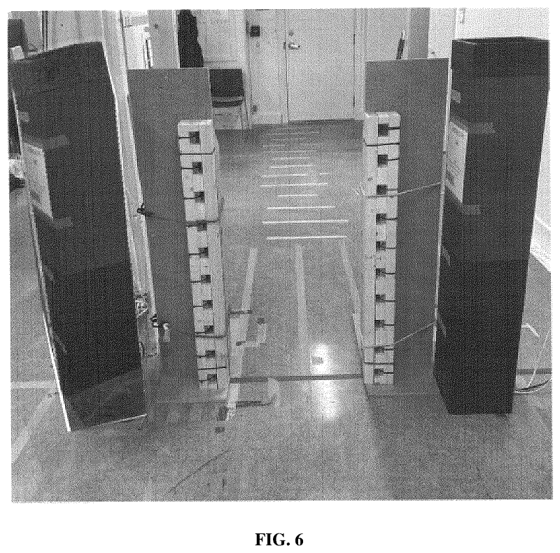

FIG. 6 is a diagram illustrating a targeted magnet sensors (TMS) demo system. According to FIG. 6, two pillars are shown to create a gateway entry. The pillars contain the hardware, sensors, and software components to create a TMS system.

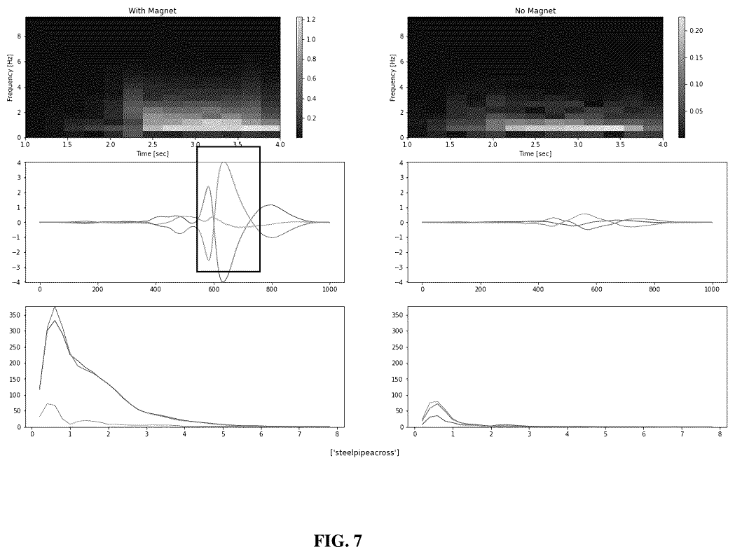

FIGS. 7-10 are diagrams representing initial experimental data collected from one embodiment of the disclosure. Multiple induction coils were positioned at different orientations on a gateway to measure the variation of the magnetic field as individuals walked through a gateway with a variety of objects. FIG. 6 is a diagram illustrating line graphs of ferrous objects as measured by a TMS system.

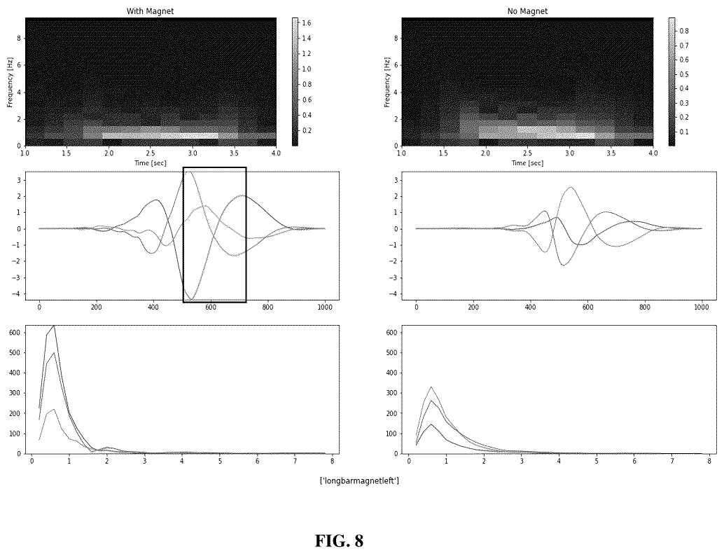

FIG. 7 is a diagram illustrating line graphs of permanent magnets as measured by a TMS system. FIG. 8 is a diagram illustrating line graphs of SW357 as measured by a TMS system. FIGS. 7-8 have three panels—the top is a spectrogram of the time series collected off the induction sensors. This shows how the frequency response of the magnetic response changes as the object passes through the gateway. The left panel of the figures is with addition of permanent magnets to induce a static magnetic field across the gateway. The right-hand figures are without the additional static magnetics and therefore no inducing field. The second row in the figures is a time series of the data collected from the induction coils. The bottom row of the figures is the Fourier spectrum of the time series showing the frequency response of the entire time series. The box highlights the portion of the time series when the majority of the interesting responses are occurring.

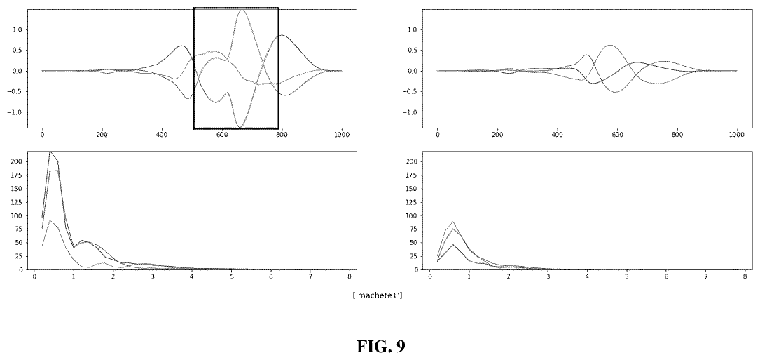

FIG. 9 is a diagram illustrating line graphs of a magnetic phone case as measured by a TMS system. According to FIG. 9, what is interesting is the response in FIG. 9 for the machete. On the left side (response with additional static field from the inducing magnet), one can see some sharp and distinct changes in the response curvature as you pass into the area with the strong inducing static field, as the machete is being magnetized from the applied field. On the right side with no inducing static field, the response shows none of this behavior and looks like a characteristic response of a remnant dipole passing through the gate. If you look at the bottom figures of the FFT of the time series response, with the applied static field, you can see an additional high frequency response peak due to the more localized nature of the applied field vs the longer wavelength response of the remnant component.

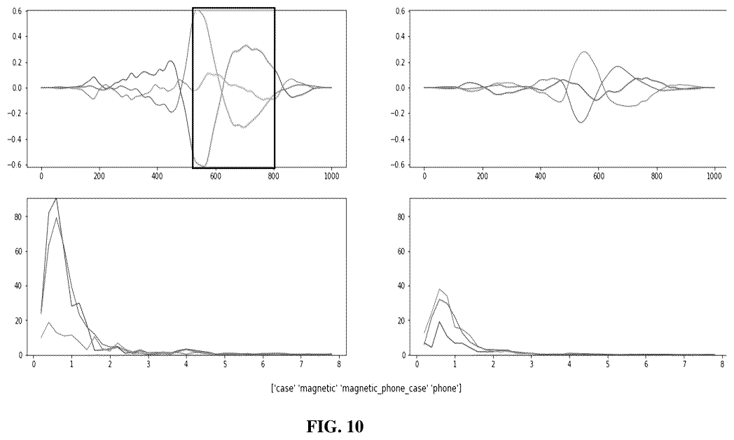

FIG. 10 is a diagram illustrating line graphs of a magnetic phone case as measured by a TMS system. According to the disclosure, clutter objects such as phones can be seen in FIG. 10. One can observe that the phone is not strongly magnetized as it passes through the inducing field. This variation in response between larger magnetically susceptible objects and electronic objects (i.e., can have small powerful remnant magnets built into them), can allow us to improve the gateway classification accuracy. The geometry and orientation of the inducing field could be constructed in such a way to help “fingerprint” the object with unique features to aid in the classification.

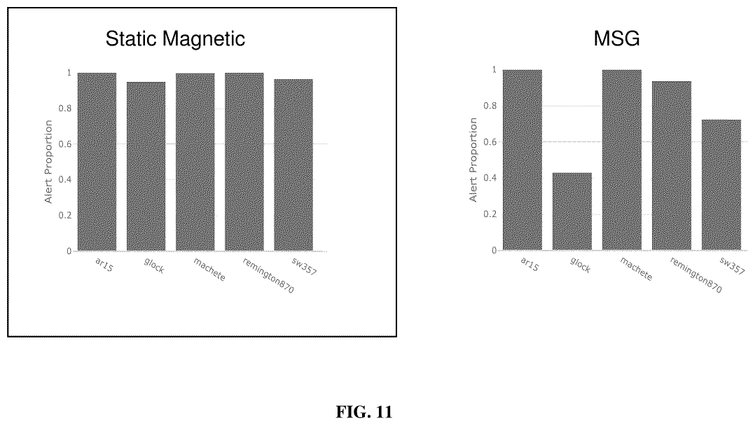

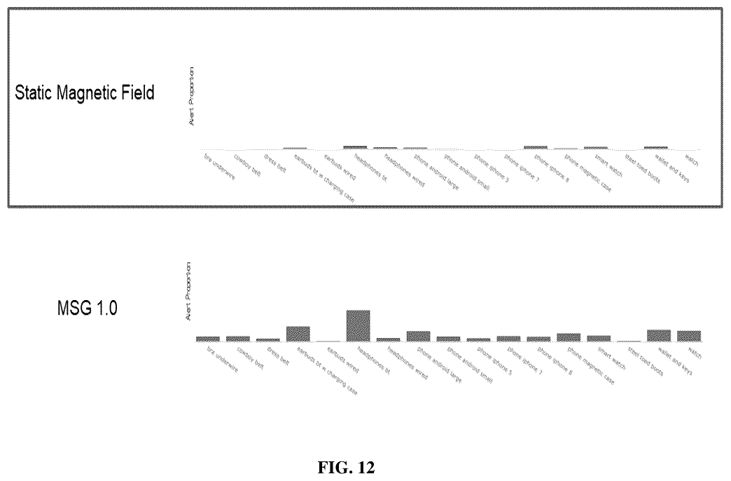

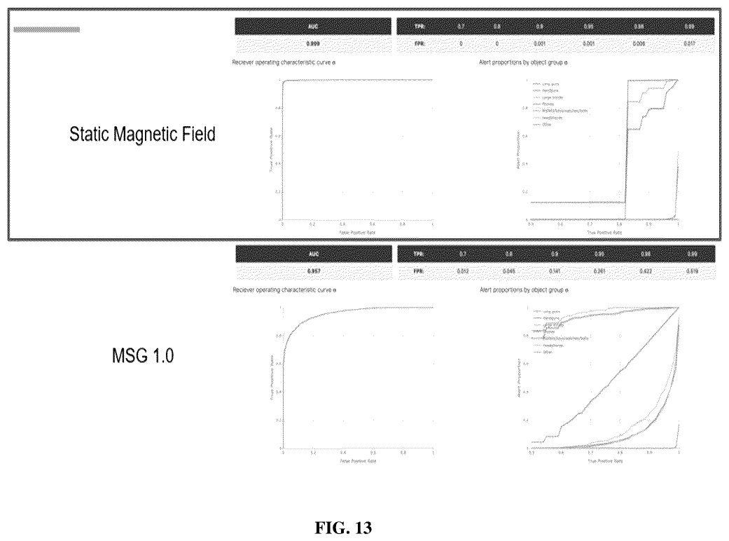

FIG. 11 is a diagram illustrating threat detection improvements by a TMS system. FIG. 12 is a diagram illustrating false positive improvements by a TMS system. FIG. 13 is a diagram illustrating upper bound performance by a TMS system.

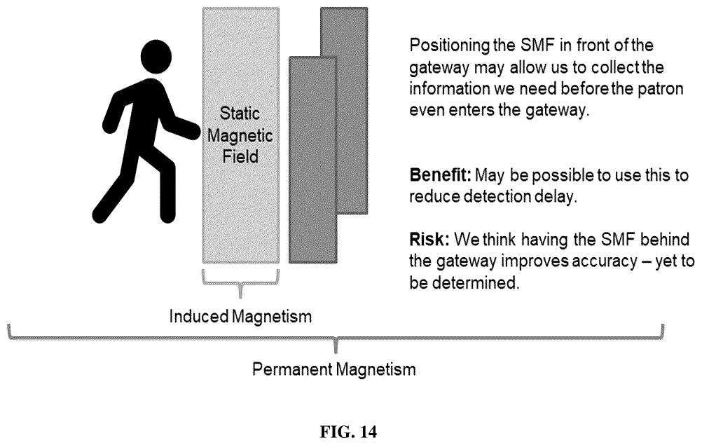

FIG. 14 is diagram illustrating an improved TMS demo system with a reduced detection delay. According to FIG. 14, two pillars are shown to create a gateway entry wherein a static magnetic field (SMF) is created in front of the two pillars. Positioning the static magnetic field (SMF) in front of the gateway may allow the system to collect information before the patron/person enters the gateway. This is beneficial as it may be possible to reduce detection delays. Further testing would be required to determine whether this disposition (vs having SMF behind gateway) will improve accuracy.

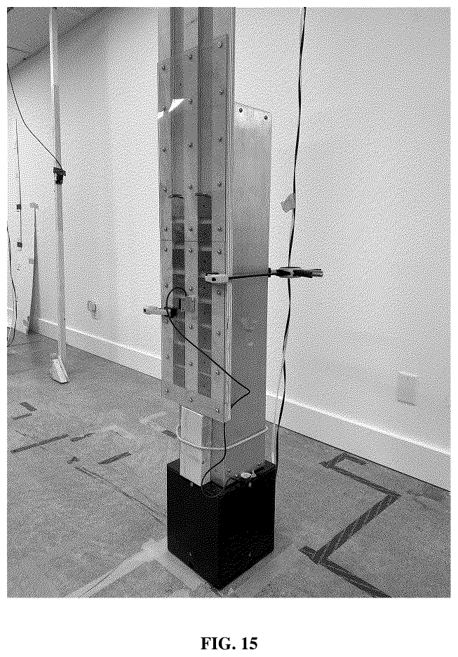

FIG. 15 is diagram illustrating a pillar of a revised TMS demo system that creates a static magnetic field (SMF) in front of the pillar of TMS gateway demo system.

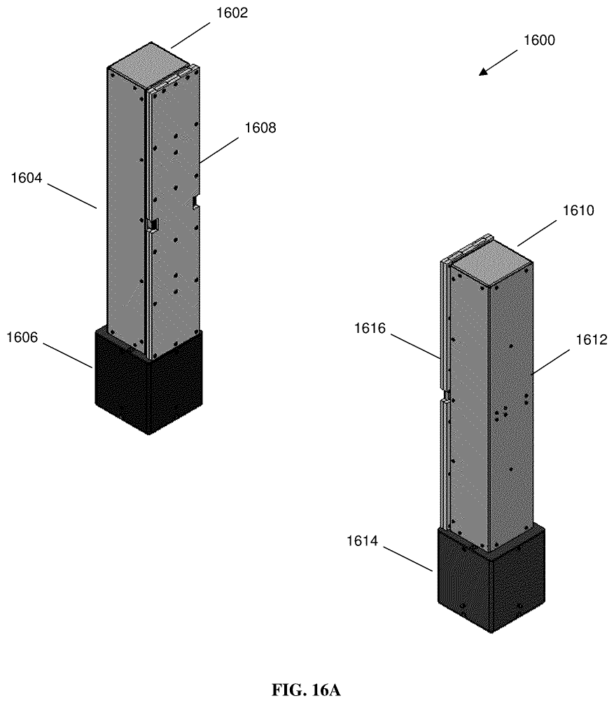

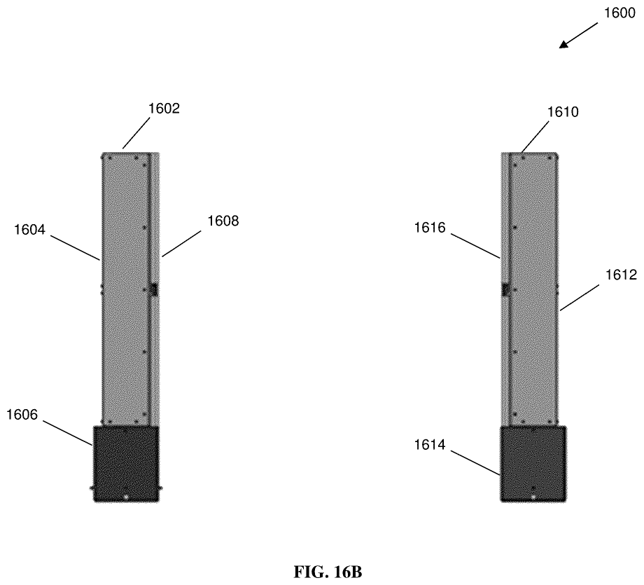

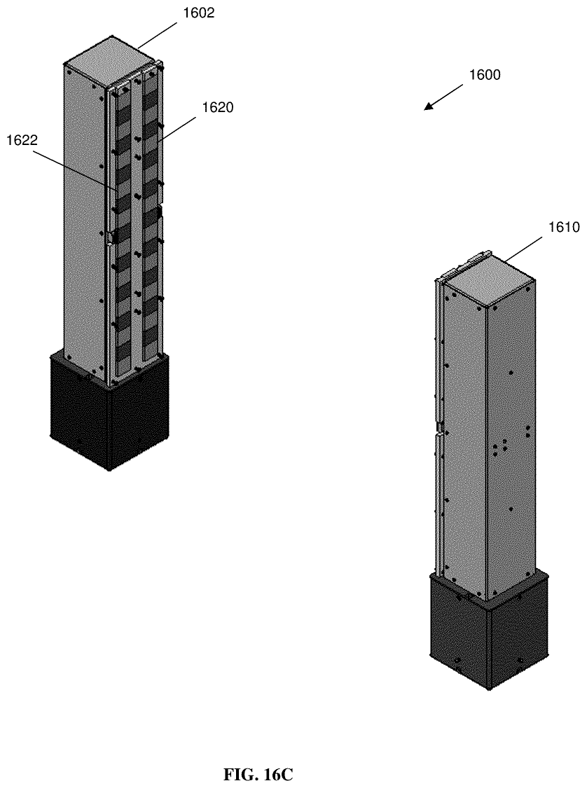

FIGS. 16A-16C are line diagrams illustrating a TMS system on a pair of pillars of an exemplary threat detection system. FIG. 16A is a line drawing of a perspective view of a pair of pillars of an exemplary threat detection system. FIG. 16B is a line drawing of a front plan view of a pair of pillars of the exemplary threat detection system.

According to FIG. 16A and FIG. 16B, threat detection system 1600 comprises pillars 1602 (Pillar1) and 1610 (Pillar2). Pillar1 1602 further comprises column 1604, base 1606 and vertical plate 1608. Pillar2 1610 further comprises column 1612, base 1614 and vertical plate 1616. Vertical plates 1608 and 1612 are secured in placed to columns 1608 and 1612 by a suitable fastening means including nuts and bolts, screws, nails, Velcro® or adhesives.

FIG. 16C is a line drawing of a perspective view of a pair of pillars of an exemplary threat detection system showing an array of magnets. According to 16C, vertical plates 1608 have been removed from pillar1 1602, revealing a pair of vertical columns of magnets 1620 and 1622.

According to FIG. 16C, pillar2 1610 also has a pair of magnets (not shown) once the vertical plate 1616 is removed.

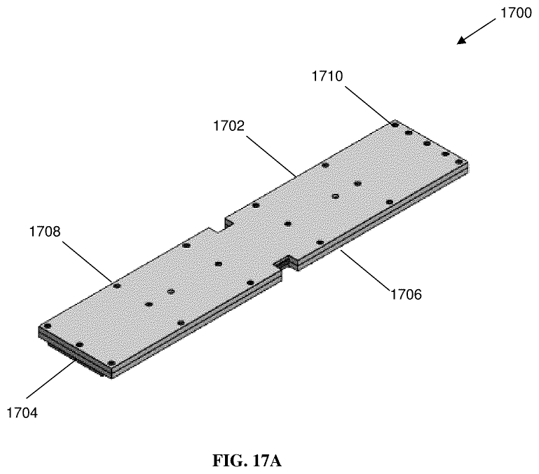

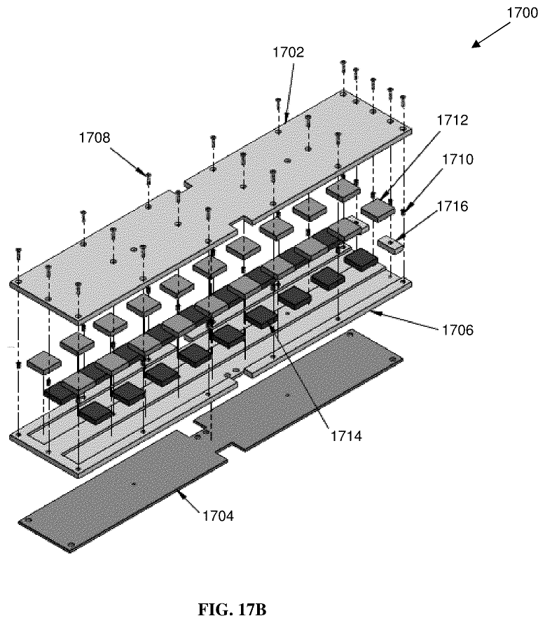

FIG. 17A is a line diagram of an assembled view of the magnet assembly. According to FIG. 17A, magnet assembly 1700 comprises magnet rail lid 1702, bottom steel plate 1704 and magnet rail 1706. Magnet rail lid 1702, bottom steel plate 1704 and magnet rail 1706 are secured in placed by a plurality of screws 1708 and 1710. Furthermore, magnet assembly 1700 may be analogous to vertical plates 1608 and 1616 shown in FIGS. 16A to 16C.

FIG. 17B is a line diagram of an exploded view of the magnet assembly. According to FIG. 17B, magnet assembly 1700 is shown in exploded view having magnet rail lid 1702, bottom steel plate 1704 and magnet rail 1706. Sandwiched between magnet rail lid 1702 and magnet rail 1706 are two rows of neo magnets (i.e., neodymium magnets) 1712 and magnet spacers 1714 with a neo magnet stopper 1716 at the end.

According to the FIG. 17B, a plurality of screws 1708 and 1710 are placed throughout the magnet assembly 1700 to screw the magnet rail lid 1702 to bottom steel plate 1704 and magnet rail thereby securing the plurality of neo magnets 1712 in place. Screws 1708 and 1719 may include McMaster-Carr ¼″-20, 1″ long brass Philips flat head screw or ¼″-20, brass flanged screw to expand inserts or other equivalent screws.

According to FIGS. 17A and 17B, magnet assembly 1700 has a weight of 40 pounds wherein the steel plate 1704 has a weight of 16 pounds. Magnet assembly 1700 has dimensions of 39 inch length, 8 inch width and 1.25 inch depth (or thickness). Each neo magnet 1712 has a magnet weight of 0.55 pounds (0.25 kilograms). According to the disclosure, each row of magnets includes 10 neo magnets. Magnet assembly 1700 has two rows with a total of 20 magnets. However, other embodiments of magnet assembly may include different size, strength and quantity of magnets.

According to the disclosure, magnet assembly 1700 may deploy permanent magnets (e.g., Neo or neodymium magnets) and/or the ability to use current loops to generate such static field. The current loops or magnets could be placed anywhere including in the pillars, the floor or the roof. The field (i.e., strength, direction, etc.) of the magnetic field could be modified as the patron passes through the gateway to increase the richness of the dataset.

According to the disclosure, the static field could be in addition to other time dependent or frequency dependent fields for other transmitters or sources. The static field could for example be a portion of a ramping on/off time domain waveform, or could be regions of near static fields, within regions of frequency domain type sinusoidal fields.

According to the disclosure, permanent magnets may be used. Furthermore, a metal shunt backing plate (i.e., bottom steel plate 1704) is installed directly behind the magnet array. This shunt backing plate can increase the field strength in desirable regions (i.e., within the gateway) and decrease the field in non-desirable regions. For example, the steel backing plate may be used to project the field stronger into the centre of the gateway. Furthermore, other permutations of a steel or susceptible backing plate can also be considered.

### Hybrid Object Detection Gateway

The optimal physical properties which can be used to discriminate objects may vary between objects. For example, some small knives may have strongly magnetized blades which make them good targets to be picked up using passive magnetic methods and remnant susceptibility, while larger objects with more metal and high conductance may be better picked and discriminated through eddy currents and active electromagnetic methods.

Currently, a multi-sensor gateway threat detection system (i.e., MSG1), such as the one provided by Xtract One Technologies™, is good at detecting small, magnetized objects such as knives with small blades as they are often strongly magnetized to the level that even a small amount of metal can be picked detected by the system. For many gateway users, it is more important to not miss threat objects (i.e., high true positive rate), even if this trade-off comes at a higher false positive rate.

While the current MSG 1 system may be able to pick up some very small objects, the performance may degrade significantly in the presence of other benign clutter objects as the data likely contains little information about the geometry of the object. Furthermore, MSG 1 has major limitations with respect to background noise in some high EMI environments due to the low frequency data band and passive nature of the system.

A further multi-sensor gateway system (i.e., MSG 2.0) was developed to improve performance both with single object walkthroughs and more complicated scenarios with multi-objects and clutter. While the test system hasn't yet been fully optimized for smaller objects, small objects with less metal mass and lower conductivity can produce no measurable data response and therefore not be discriminated against in the current version of the technology.

It may be desirable to have a combined hybrid multi-physics solution that combines the best of both solutions (transmitters, and receivers, etc.) into a single combined hybrid gateway.

In typical gateway systems, the pillars on each side of a lane are usually connected, either at the top by an arch or at the bottom, to power the system and transfer data from a secondary pillar to a primary pillar. This makes it difficult for the systems to be concealed and blend in the environment they are deployed in. For pillars connected at the floor level, a base plate has to be constructed to protect wires and avoid tripping people passing through the system. Further, these systems are bulky, and difficult to move around. They typically need to be installed in a fixed location and are less suited as a mobile solution.

This disclosure removes the need for wiring between the pillars, allowing this system to be better concealed in its deployment environment. It will provide seamless threat scanning experience which is an utmost requirement of the public safety industry. The system is easy to move around with and can be easily deployed in a mobile application.

This disclosure describes a wire-free multi-sensor gateway. The gateway consists of two pillars that form a gateway for public screening. Each pillar contains magnetic sensors, and an acquisition board with a wireless or WiFi connectivity to enable data transfer to a server or an embedded solution. In a preferred embodiment, the system utilizes WiFi wireless connectivity, however, other wireless connectivity alternatives such as cellular, Bluetooth®, Zigbee® and near field communications (NFC) protocols may be considered.

The system can either be powered using an uninterruptible power supply (UPS) or battery solution if the system needs to be fully wire-free. The alignment of the towers is achieved with an optical switch.

The acquisition board captures the information from the sensors and uses wireless connectivity to send the information to the computing server or an embedded computer. The computer (e.g., computing server or embedded computer) combines the information from each pillar and uses AI to form a decision on the presence of a threat object, as a person walks through the gateway.

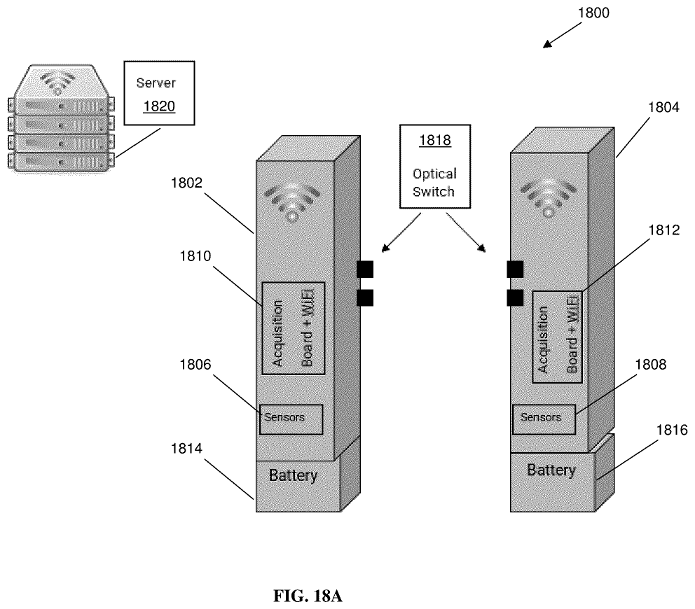

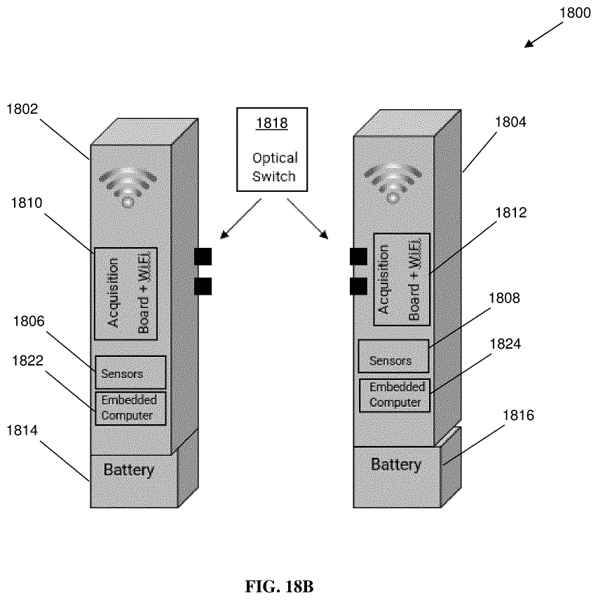

FIG. 18A is a diagram describing elements of one example implementation of an exemplary hybrid gateway system. FIG. 18B is a diagram describing elements of further embodiment of the hybrid gateway system with an embedded computer.

According to the disclosure, FIGS. 18A and 18B include hybrid gateway system 1800 and the following elements:
Two pillars 1802 and 1804 which together form a gateway for public screening.
Sensors 1806 and 1808 to detect threats as a person walks through the gateway. These may be magnetic sensors to detect ferromagnetic threat signatures, gas or particulate sensors to detect specific substances, some other kind of sensors to detect threats, or a combination of sensor types.
An acquisition boards 1810 and 1812 on each pillar, wherein the acquisition boards 1810 and 1812 takes the data from the sensor 1806 and 1808, optionally processes it, and sends it to the server via WiFi®.
An optional battery 1814 and 1816 in each pillar 1802 and 1804, to allow the pillar to be fully wire-free. In further implementations, the pillars 1802 and 1804 may be powered by a main power connection, an outboard battery, an electric power generator, solar power, or some other means, any of which means may be directly integrated into the pillar or connected to the pillar by wiring.
At least one optical switch 1818, or other means of aligning the pillars such as a camera sensor, physical alignment sensor, or other alignment system.
A server 1820 or embedded device 1822 and 1824 that combines the information from the pillars 1802 and 1804 to form a decision on the presence of a threat, as a person walks through the gateway. Such a decision may sound an alarm, alert a user, provide a wireless notification, cause an alert to be logged or cause some other action to be taken. In one implementation, the functionality of the server 1820/edge device may be integrated into a pillar. In one implementation, the functionality of the server/edge device may be integrated into the acquisition board on the pillar such that no WiFi® data transfer is necessary from that pillar's acquisition board.

According to further embodiments of the disclosure, other physical property information can be from completely different sensor/system information such as CMR (dielectric constant) and that the two concepts can work together even with completely different stand-alone systems.

According to further embodiments of this disclosure, further systems can be set up for alignment of multiple magnet arrays in a variety of locations so that their fields are constructed in the middle of the gateway. It is one way of getting a stronger field in the middle without making the field stronger at the edges.

According to further embodiments of this disclosure, movable remote pillars can be used to induce our magnetic field. The remote pillars could be distributed around in any arbitrary configuration to induce the geometry of the desired magnetic field, and if using static magnets, would not require any electrical power, or connectivity with the rest of the system which would be nice from a rapid modular deployment perspective and ability to configure the system for the environment at hand.

According to further embodiments of the disclosure, the magnetic sources (i.e., either current loops or static magnetics) can be embedded within pillars, on the ground in mats or under the floor, or above the patron in the roof or arch. Furthermore, these magnetic sources can be stationary and fixed, or movable.

According to the disclosure, a magnet assembly configured as a targeted magnet sensor (TMS) to create a static magnetic field for a threat detection system to detect permanently magnetized objects is disclosed. The magnet assembly comprises a magnet rail lid, a magnet rail frame, a bottom steel plate, a static field means to generate a static field, and a securing means to secure the magnet rail lid, static field means, magnet rail frame and bottom steel plate to form an assembled magnet assembly.

According to the disclosure, the static field means of the magnet assembly further comprising row of magnets consisting of a plurality of permanent magnets and a plurality of magnet spacers interleaved between the permanent magnets. The two rows of magnets are placed between the magnet rail frame and the magnet rail lid.

According to the disclosure, the permanent magnets of the magnet assembly are neodymium magnets. Furthermore, the magnetic assembly further comprises a magnet spacer placed at the end of the row of permanent magnets.

According to the disclosure, the static field means of the magnetic assembly further comprising a current loop. The securing means of the magnetic assembly is selected from a list consisting of screws, nuts, bolts, spacer, adhesives, Velcro® or fasteners. According to the disclosure, the vertical plates of the magnetic assembly are configured as vertical plates within a pillar of a threat detection system.

According to the disclosure, a computer-implemented threat detection system to detect magnetized objects has been disclosed. The threat detection system comprises a processor, a first pillar having a first targeted magnet sensor, a second pillar having second targeted magnet sensor, a Wi-Fi® module on the first pillar configured for the pillars to communicate over Wi-Fi®, a platform computer server and processor configured to receive data and process the data.

According to the disclosure, the threat detection system is configured wherein the targeted magnet sensors of the first and second pillars are configured as magnet assembly vertical plates facing each other. The magnet assembly further comprises a magnet rail lid, a magnet rail frame, a bottom steel plate, a static field means to generate a static field, and a securing means to secure the magnet rail lid, rows of magnets, magnet rail frame and bottom steel plate to form an assembled magnet assembly.

According to the disclosure, the static field means of the threat detection system consist of a row of magnets further comprising a plurality of permanent magnets, and a plurality of magnet spacers interleaved between the permanent magnets. The two rows of magnets are placed between the magnet rail frame and the magnet rail lid.

According to the disclosure, the permanent magnets of the threat detection system are neodymium magnets. Furthermore, the magnet assembly of threat detection system further comprises a magnet spacer placed at the end of the row of permanent magnets. The magnet assembly of threat detection system further comprises two rows of magnets placed between the magnet rail frame and the magnet rail lid.

According to the disclosure, the static field means of the threat detection system further comprises current loop. The pillars of the threat detection system further comprise a vertical column and a base. The magnet assembly of the threat detection system is configured as vertical plates within a pillar of the threat detection system.

According to the disclosure, a hybrid threat detection system, using a hybrid gateway system to detect a threat is disclosed. The hybrid detection system comprises a processor, a first pillar having a first sensor, a second pillar having second sensor, a platform computer server and the processor configured to receive data and process the data, a Wi-Fi® module on the first or second pillar configured for the pillars to communicate over Wi-Fi®, an acquisition board on first and second pillar configured to receive data from the first and second sensors, process the data and sends it to the server via WiFi® and an alignment means to align the pillars.

According to the disclosure, the first and second sensors of the hybrid threat detection system are configured to detect threats as a person walks through the gateway. The server of the hybrid threat detection system combines the information from the pillars to form a decision on the presence of a threat, as a person walks through the gateway.

According to the disclosure, the first sensor and second sensor of the hybrid threat detection system are targeted magnetic sensors to detect ferromagnetic threat signatures, gas or particulate sensors to detect specific substances, thermal sensors to detect heat signatures, and other electromagnetic receivers capable of measuring electromagnetic response across the full electromagnetic spectrum. The other electromagnetic receivers further comprise visible, low frequency EM and radar.

According to the disclosure, the hybrid threat detection system further comprises a battery in each pillar, to allow the pillar to be fully wire-free. The pillars hybrid threat detection system is powered by a main power connection, an outboard battery, an electric power generator, solar power, or some other means, any of which means may be directly integrated into the pillar or connected to the pillar by wiring.

According to the disclosure, the alignment means of the hybrid detection system configured to align pillars can be an optical switch, a camera sensor or a physical alignment sensor.

According to the disclosure, when a threat is detected by the hybrid detection system, a decision is made to sound an alarm, alert a user, provide a wireless notification, cause an alert to be logged or cause some other action to be triggered.

According to the disclosure, the server of the hybrid detection system is embedded device integrated in the first or second pillar. Furthermore, the server is integrated into the acquisition board in the first or second pillar such that no WiFi® data transfer is necessary from that pillar's acquisition board.

Implementations disclosed herein provide systems, methods, and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code, or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A magnet assembly configured as a targeted magnet sensor (TMS) to create a static magnetic field for a threat detection system to detect permanently magnetized objects, the magnet assembly comprising:
a magnet rail lid;
a magnet rail frame;
a bottom steel plate;
a static field means to generate a static field;
a securing means to secure the magnet rail lid, static field means, magnet rail frame and bottom steel plate to form an assembled magnet assembly.

2. The magnetic assembly of claim 1 wherein the static field means further comprising row of magnets further comprising:
a plurality of permanent magnets; and
a plurality of magnet spacers interleaved between the permanent magnets;
wherein two rows of magnets are placed between the magnet rail frame and the magnet rail lid.

3. The magnetic assembly of claim 1 wherein the static field means further comprising a current loop.

4. The magnetic assembly of claim 1 wherein the securing means is selected from list consisting of screws, nuts, bolts, spacer, adhesives, Velcro or fasteners.

5. The magnetic assembly of claim 1 configured as vertical plates within a pillar of a threat detection system.

6. The magnetic assembly of claim 2 wherein the permanent magnets are neodymium magnets.

7. The magnetic assembly of claim 2 further comprising a magnet spacer placed at the end of the row of permanent magnets.

8. A computer-implemented threat detection system to detect magnetized objects comprising:
a processor;
a first pillar having a first targeted magnet sensor;
a second pillar having second targeted magnet sensor;
a Wi-Fi® module on the first pillar configured for the pillars to communicate over Wi-Fi®;
a platform computer server and processor configured to receive data and process the data;
wherein the targeted magnet sensors of the first and second pillars is configured as magnet assembly vertical plates facing each other, the magnet assembly further comprising:
a magnet rail lid;
a magnet rail frame;
a bottom steel plate;
a static field means to generate a static field;
a securing means to secure the magnet rail lid, rows of magnets, magnet rail frame and bottom steel plate to form an assembled magnet assembly.

9. The magnetic assembly of claim 8 wherein the static field means further comprising row of magnets further comprising:
a plurality of permanent magnets; and
a plurality of magnet spacers interleaved between the permanent magnets;
wherein two rows of magnets are placed between the magnet rail frame and the magnet rail lid.

10. The magnetic assembly of claim 8 wherein the static field means further comprising a current loop.

11. The threat detection system of claim 8 wherein the pillars further comprises a vertical column and a base.

12. The threat detection system of claim 8 wherein the magnet assembly is configured as vertical plates within a pillar of a threat detection system.

13. The threat detection system of claim 8 wherein the permanent magnets are neodymium magnets.

14. The threat detection system of claim 9 further comprising magnet spacer placed at the end of the row of permanent magnets.

15. The threat detection system of claim 8 wherein the magnet assembly further comprises two rows of magnets placed between the magnet rail frame and the magnet rail lid.

16. A hybrid threat detection system, using a hybrid gateway system to detect a threat, the hybrid detection system comprising:
a processor;
a first pillar having a first sensor;
a second pillar having second sensor;
a platform computer server and the processor configured to receive data and process the data;
a Wi-Fi® module on the first or second pillar configured for the pillars to communicate over Wi-Fi®;
an acquisition board on first and second pillar configured to receive data from the first and second sensors, process the data and sends it to the server via WiFi®.
an alignment means to align the first and second pillar;
wherein first and second sensors to detect threats as a person walks through the gateway;
wherein server combines the information from the pillars to form a decision on the presence of a threat, as a person walks through the gateway.

17. The hybrid threat detection system of claim 16 wherein the first sensor and second sensor are targeted magnetic sensors to detect ferromagnetic threat signatures, gas or particulate sensors to detect specific substances, thermal sensors to detect heat signatures, and other electromagnetic receivers capable of measuring electromagnetic response across the full electromagnetic spectrum.

18. The hybrid threat detection system of claim 16 wherein the other electromagnetic receivers further comprising visible, low frequency EM and radar.

19. The hybrid threat detection system of claim 16 further comprising a battery in each pillar, to allow the pillar to be fully wire-free.

20. The hybrid threat detection system of claim 16 wherein the pillars are be powered by a main power connection, an outboard battery, an electric power generator, solar power, or some other means, any of which means be directly integrated into the pillar or connected to the pillar by wiring.

21. The hybrid threat detection system of claim 16 wherein the alignment means to align pillars can be an optical switch, a camera sensor or a physical alignment sensor.

22. The hybrid threat detection system of claim 16 wherein when a threat is detected, a decision to sound an alarm, alert a user, provide a wireless notification, cause an alert to be logged or cause some other action is triggered.

23. The hybrid threat detection system of claim 16 wherein the server is embedded device integrated in the first or second pillar.

24. The hybrid threat detection system of claim 16 the server is integrated into the acquisition board in the first or second pillar such that no WiFi® data transfer is necessary from that pillar's acquisition board.
